(19) United States
(12) Patent Application Publication
(10) Pub. No.: US 2019/0064103 A1
(43) Pub. Date: Feb. 28, 2019

(54) Method of modifying non-planar electrodes

(71) Applicants: Phoenix Silicon International Corporation, Hsinchu City (TW); National Chung Hsing University, Taichung City (TW)

(72) Inventors: Gou-Jen Wang, Taichung City (TW); Yuan-Chi Lin, Taichung City (TW); Ching-Wen Li, Tainan City (TW); Mike Yang, Hsinchu City (TW); Po-Chih Wu, Hsinchu City (TW); Hsueh-Chuan Liao, Hsinchu City (TW); Maoee Tsen, Hsinchu City (TW)

(21) Appl. No.: 16/105,298

(22) Filed: Aug. 20, 2018

(30) Foreign Application Priority Data
Aug. 22, 2017 (TW) 106128401

(51) Int. Cl. G01N 27/403; G01N 27/327

(52) U.S. Cl. CPC G01N 27/403; B82Y 30/00; G01N 27/327

(57) ABSTRACT

The present invention discloses a method for modifying a non-planar electrode, in which a short-chain molecule is used as a connector. The short-chain molecule is an alcohol compound having a thiol group at both ends. Therefore, the thiol groups at both the ends of the short-chain molecule can be separately bonded to a nanoparticle and a surface of an electrode, so that a plurality of nanoparticles are arranged on a surface of a non-planar electrode.

### BACKGROUND OF THE INVENTION

### 1. Field of the Invention

The present invention relates to a method for manufacturing a biomedical tool, and in particular, to a method for modifying a non-planar electrode.

### 2. Description of the Related Art

With the growing demand of fast detection, an electrochemical sensing chip becomes a major development focus of biomedical detection tools at present. Instead of common planar materials or film materials, nanomaterials such as nanoparticles, nanowires, and nanorod arrays have been widely applied to various detection apparatuses. The main reason lies in that zero-dimensional or one-dimensional nanomaterials can be grown or fixed on a detection substrate and arranged regularly into uniform nanostructure arrays, so that a surface area of the substrate can be greatly increased, thereby improving sensing performance. A glucose sensing chip is used as an example. A currently developed enzyme-free glucose detection chip uses a nanostructure of the chip and an electrochemical technology to achieve the effect of sensing a glucose concentration.

Currently, in most methods of fixing or growing nanoparticles such as nanogold on a detection substrate, nanoparticles are mixed into a colloid material and then applied to a surface of an electrode, so that nanoparticles are fixed on the substrate. A common colloid material is carbon nanotube, graphene, chitosan, or the like; or nanoparticles are deposited on a surface of the detection substrate by using 3-aminopropyl-trimethoxysilane (referred to as APTMS hereinafter). When nanoparticles have excessively large particle sizes, nanoparticles cannot be stably fixed on the substrate by using the foregoing methods, resulting in interference with a detection result to cause misjudgment. In addition, if a cleaning step is required in a detection procedure, nanoparticles are not stably attached on the substrate and therefore may be washed off the substrate. As a result, the detection result is affected, and the service life of a detection chip is reduced.

### SUMMARY OF THE INVENTION

The main objective of the present invention is to provide a method for modifying a non-planar electrode, so that nanoparticles can be uniformly attached on a non-planar electrode, so as to increase a sensing area of the electrode and improve the sensitivity and accuracy of detection.

Another objective of the present invention is to provide a method for modifying a non-planar electrode, so that nanoparticles can be stably attached on a non-planar electrode, so as to prevent nanoparticles from falling off the electrode easily under the effect of an external force, thereby effectively increasing the number of times that the electrode can be used and maintain the stability of a detection result.

In view of this, to achieve the foregoing objectives, the present invention discloses a method for modifying a non-planar electrode, in which a short-chain molecule is used as a connector, where the short-chain molecule is an alcohol compound having a thiol group at both ends. Therefore, the thiol groups at both the ends of the short-chain molecule can be separately bonded to a nanoparticle and a surface of an electrode, so that a plurality of nanoparticles are arranged on a surface of a non-planar electrode.

Furthermore, the method for modifying a non-planar electrode disclosed in the present invention includes the following steps:

Step a: placing at least one electrode in a dithiol solution whose concentration is greater than 2 mM, to enable an end of a dithiol to be attached on a surface of the electrode, where the concentration is 2 mM, 5 mM, 10 mM, 1 M, 2 M, 3 M, 4 M, 5 M, 6 M or 6.4 M; and

Step b: placing a plurality of nanogold particles on the electrode in Step a, to enable the other end of a dithiol to be bonded to a nanogold particle.

The diameter of the nanogold particle is 1 nanometer to 50 nanometers, for example, is 1 nm, 5 nm, 10 nm, 20 nm, 25 nm, 30 nm, 35 nm, 40 nm, 45 nm or 50 nm.

The nanogold particle is prepared into a solution whose concentration is between 10 wt % and 75 wt %. When the concentration is 10 wt %, an oxidation-reduction characteristic and the structural integrity of the electrode can be improved, and at the same time the fabrication costs can be reduced.

The electrode is a micron-sized protrusion and is cylindrical or hemispherical. When the electrode is hemispherical, the diameter of the hemispherical electrode is 1 micron to 20 microns, for example, 1 micron, 2 microns, 5 microns, 8 microns, 10 microns, 15 microns, 16 microns, 18 microns or 20 microns.

The electrode is disposed on a substrate.

For example, the method for modifying a non-planar electrode in the present invention can be applied to a fabrication process of fabricating an electrochemical sensing chip or can be applied to a detection chip in the biomedical field, and includes the following steps: Step a: taking a substrate, where a surface of the substrate has a plurality of protruding electrodes;

Step b: placing the substrate in a dithiol solution whose concentration is greater than 2 mM;

Step c: drying the substrate in Step b, and then placing a nanogold particle solution having a predetermined concentration on a surface, having the electrodes, of the substrate; and

Step d: obtaining a sensing chip.

The nanogold particle is prepared into a solution whose concentration is between 10 wt % and 75 wt %.

The diameter of the nanogold particle is 1 nanometer to 50 nanometers, for example, is 1 nm, 5 nm, 10 nm, 20 nm, 25 nm, 30 nm, 35 nm, 40 nm, 45 nm or 50 nm.

The electrode is micron-sized and hemispherical, and the diameter of the electrode is 1 micron to 20 microns, for example, is 1 micron, 2 microns, 5 microns, 8 microns, 10 microns, 15 microns, 16 microns, 18 microns or 20 microns.

### BRIEF DESCRIPTION OF THE DRAWINGS

FIG. 1(A) is a schematic view of a silicon substrate having a photoresist layer.

FIG. 1(B) is a schematic view of a photomask pattern.

FIG. 1(C) is a schematic view of a silicon substrate having a cylindrical array.

FIG. 1(D) is a schematic view of a silicon substrate having a hemispherical array.

FIG. 2 is a schematic view of a microarray chip after packaging.

FIG. 3(A) shows a result of observing a hexagonal cylindrical array chip by using a field emission scanning electron microscope.

FIG. 3(B) shows a result of observing a hemispherical array chip by using a field emission scanning electron microscope.

FIG. 4(A) shows a structure of a microarray chip of performing electrode surface modification by using a nanogold particle solution whose concentration is 100 wt %.

FIG. 4(B) shows a structure of a microarray chip of performing electrode surface modification by using a nanogold particle solution whose concentration is 50 wt %.

FIG. 4(C) shows a structure of a microarray chip of performing electrode surface modification by using a nanogold particle solution whose concentration is 25 wt %.

FIG. 4(D) shows a structure of a microarray chip of performing electrode surface modification by using a nanogold particle solution whose concentration is 10 wt %.

FIG. 4(E) is an enlarged view of a single electrode in FIG. 4(D).

FIG. 5(A) shows results of measurement using cyclic voltammetry (CV) after electrode modification is performed using nanogold particle solutions having different concentrations.

FIG. 5(B) shows results of measurement using CV after electrode modification is performed using nanogold particle solutions having different concentrations.

FIG. 6 shows results of measurement using CV after electrode modification is performed using 1,6-HDT solutions having different concentrations.

FIG. 7(A) shows results of detecting a microarray chip disclosed in the present invention and a conventional planar gold electrode using CV scanning.

FIG. 7(B) is a time-current curve converted from FIG. 7(A).

FIG. 8 shows results of a stability test of a microarray chip disclosed in the present invention.

FIG. 9(A) shows results of CV detection of a microarray chip disclosed in the present invention at different scan rates.

FIG. 9(B) is a curve illustrating a relationship between a peak current drawn in FIG. 9(A) and a scan rate.

FIG. 10(A) is a diagram illustrating an electric potential-current (E-I) relationship in a microarray chip disclosed in the present invention obtained using CV with different glucose concentrations.

FIG. 10(B) is a diagram illustrating a relationship between a peak oxidation current (an electric potential is 0.4 V) obtained according to FIG. 10(A) and a corresponding glucose concentration.

FIG. 11 is a diagram illustrating an oxidation current-time (I-T) relationship of glucose and interfering substances measured using chronoamperometry after electrode surface modification is performed on a microarray chip disclosed in the present invention by using Nafion having different concentrations.

### DETAILED DESCRIPTION OF THE PREFERRED EMBODIMENTS

In a method for modifying a non-planar electrode disclosed in the present invention, a short-chain molecule having double thiol groups is used as a connector, so that the thiol groups at two ends can be separately connected to a surface of an electrode and a nanoparticle to enable the nanoparticle to be stably joined to the electrode through the connector. Furthermore, the method for modifying a non-planar electrode disclosed in the present invention can be applied to fabrication of a sensing chip, so that an electrode of the sensing chip can have higher reaction efficiency and stability after being modified. A fabrication process of the sensing chip and a shape or an arrangement manner of the electrode of the sensing chip can be completed by a person skilled in the art of the present invention according to common knowledge, and are not used to limit the technical features of the present invention.

Furthermore, a short-chain molecule having double thiol groups disclosed in the present invention is a dithiol such as 1,6-hexanedithiol (1,6-hexanedithiol, referred to as 1,6-HDT hereinafter), meso-2,3-dimercaptosuccinic acid (DMSA), dihydrolipoic acid (DHLA), 1,2-ethanedithiol, benzene-1,2-dithiol, benzene-1,4-dithiol, and benzene-1,3-dithiol.

For example, the sensing chip is a micron hemispherical array chip fabricated by combining a photolithography fabrication process and a photoresist heat fusion method, or is a microarray chip fabricated by using an etching technology. The electrode is a protrusion or a dent.

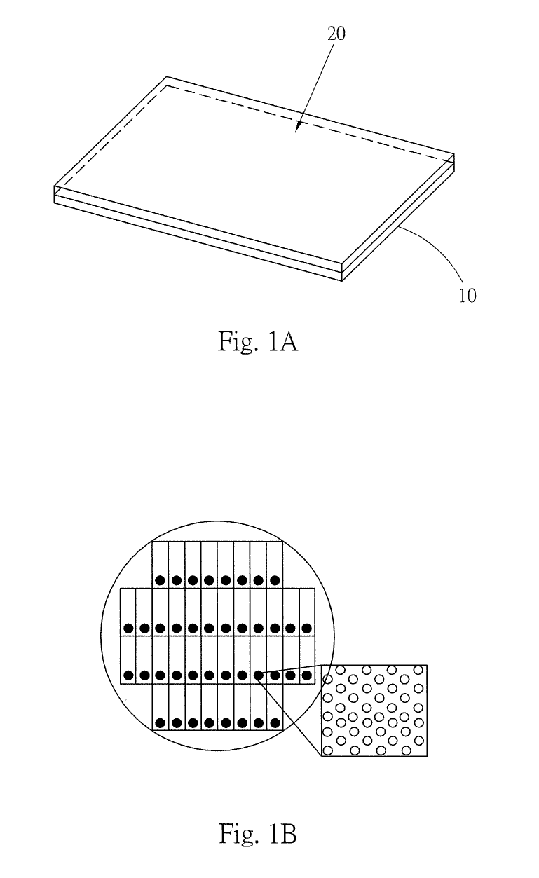

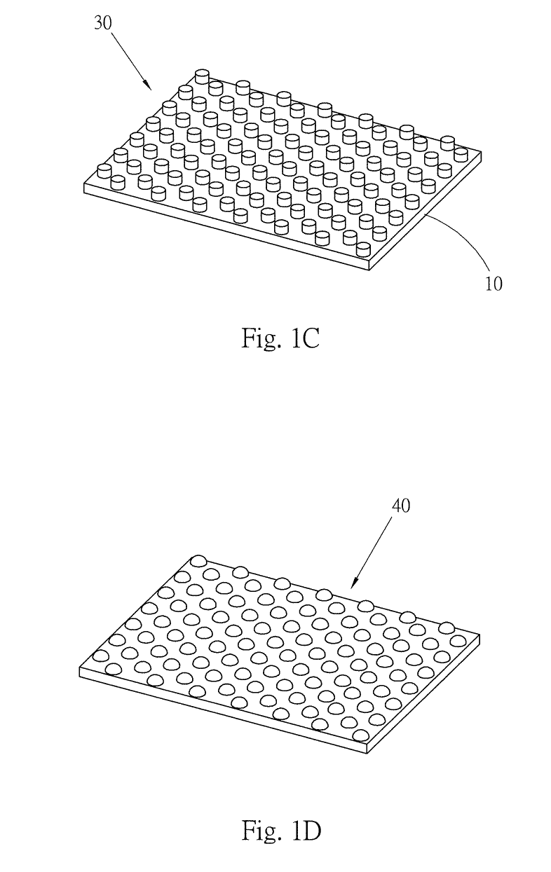

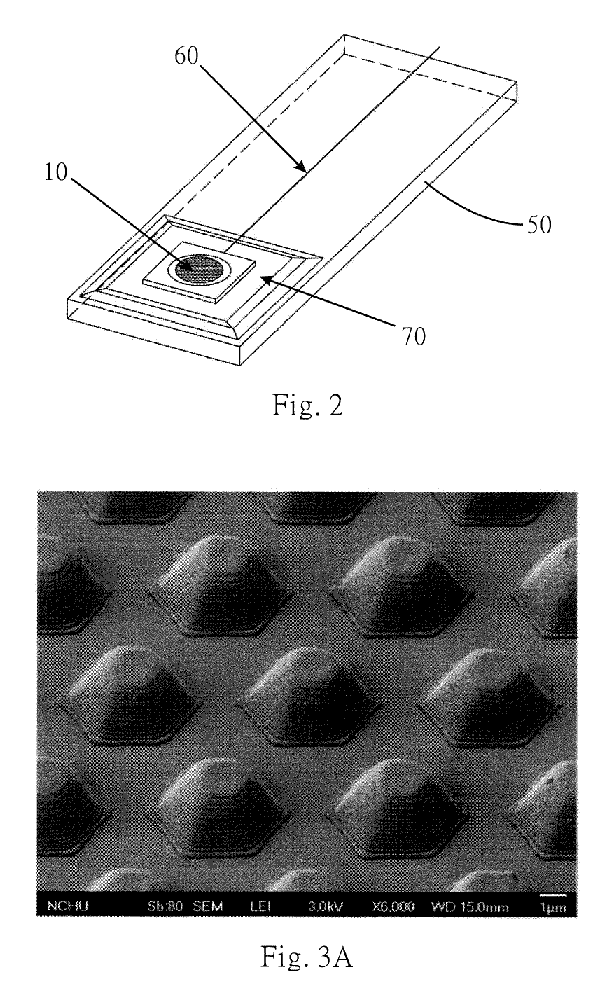

Further, referring to FIG. 1, a fabrication process of a microarray chip includes: First, a photoresist layer (20) is applied on a silicon substrate (10). A pattern designed on a photomask is transferred to the silicon substrate (10) by using a semiconductor photolithography technique. The silicon substrate (10) having a cylindrical array is formed. The silicon substrate (10) having a cylindrical array is then heated. Under the effects of surface tension and photoresist cohesion, a cylindrical array (30) is softened to form a hemispherical array (40). A plurality of hemispherical electrodes are then formed after a thin gold film is sputtered on the hemispherical array. Subsequently, by means of the method for modifying a non-planar electrode disclosed in the present invention, by using a short-chain molecule having double thiol groups, for example, 1,6-hexanedithiol, DMSA, DHLA, 1,2-ethanedithiol, benzene-1,2-dithiol, benzene-1,4-dithiol or benzene-1,3-dithiol, a thiol group end is joined to a surface of each electrode, and the other thiol group end is joined to a nanoparticle, to enable a plurality of nanoparticles to be uniformly disposed on the surfaces of the electrodes. The modified silicon substrate is packaged, as shown in FIG. 2. That is, the modified silicon substrate (10) is disposed on a slide (50) having a conductor (60), the conductor is connected to the modified silicon substrate (10), a Sealing film (70) having a round hole is then used to cover the modified silicon substrate (10) to fix the modified silicon substrate (10) on the slide (50), and a silica gel is used to reinforcing a packaging effect.

Before being prepared into a nanogold particle solution by using double distilled water, the nanogold particle is first preprocessed by using a sodium citrate aqueous solution having a predetermined concentration to reduce particle sizes of nanogold particles and increase the dispersity of nanogold particles in the solution. The concentration of the sodium citrate aqueous solution is 0.05 mM to 4 mM. Further, the effect is optimal when the concentration of the sodium citrate aqueous solution is approximately 3.8 mM to 3.9 mM.

Several examples of the present invention and the accompanying drawings are further described below.

In electrochemical measurement and analysis in the following examples, an electrochemical potentiostat (SP-150) issued to perform detection. The electrochemical potentiostat uses a three-electrode measurement system. A working electrode is connected to a microarray chip. A platinum electrode is used as an auxiliary electrode. Finally, Ag/AgCl is used as a reference electrode. A current generated between an object to be tested and an electrode interface is then detected, and various measurement data are analyzed.

Unless otherwise described, conditions of CV used in the following examples are as follows: An electric potential scan range is −0.6 to 0.6V, a scan rate is 100 mV/sec, and an impedance solution having 5 mM yellow prussiate (Fe(CN)6⁴⁻), 5 mM red prussiate (Fe(CN)6³⁻), and a PBS buffer solution (pH 7.4) is used.

### Example 1: Prepare Nanogold Particles

A nanogold particle solution whose concentration is wt % is prepared. 1.5 mL of chlorauric acid and approximately 88.63 mL of double deionized water are first mixed and heated to a boiling state. 9.87 mL of sodium citrate aqueous solutions having different concentrations are then added. The mixture is kept boiling and is stirred continuously until the solution turns wine red. After the solution is cooled, a centrifuge is used to purify the solution, so as to obtain a nanogold particle solution. A dynamic light scattering (DLS) instrument is used to analyze the particle sizes and dispersity of the nanogold particles. The results are shown in the following Table 1.

TABLE 1
Analysis results of particle sizes of nanogold
particles
Sodium citrate concentration (mM) Nanogold
particle size (nm) Dispersity (Pdi)

| Sodium citrate | | |
|---|---|---|
| concentration | Nanogold | Dispersity |
| (mM) | particle size (nm) | (Pdi) |
| 0.05 | 42.99 | 0.390 |
| 1.56 | 27.2 | 0.510 |
| 1.8 | 30.29 | 0.525 |
| 2.34 | 23.07 | 0.259 |
| 3.82 | 13.49 | 0.508 |

As can be learned from the content in Table 1, when the concentration of the sodium citrate solution is 3.82 mM, the particle size of the nanogold particle is minimum and is 13.49 nm. In other words, a sodium citrate solution should be added during the preparation of the nanoparticle solution used in the method for modifying a non-planar electrode disclosed in the present invention. When the concentration of the sodium citrate solution is approximately 3 mM to 4 mM, the particle size of the nanogold particle can be minimum, so as to achieve a more desirable modification effect.

### Example 2: Manufacture a Microarray Chip

The microarray chip can be fabricated by performing the following steps on a die having a predetermined size:

Cleaning Step

A die whose thickness is 500 μm and size is 6 inches is taken. The die is placed in a solution that contains acetone, alcohol, and double deionized water. Cleaning is performed by using an ultrasonic vibrator to remove impurities and grease on the surface of the die. Subsequently, the die is dried.

Photolithography Step

First, a surfactant such as bis(trimethylsilyl)amine (HMDS) is applied on the die. Next, a photoresist having a predetermined thickness is applied. For example, the AZ 1518 photoresist whose thickness is approximately 2 μm is applied and heated, so that the photoresist is cured into a thin film. Next, a photomask pattern is transferred to the die. The photomask pattern includes 40 rectangular blocks. Each rectangular block includes an array of over 2,000,000 circles that are tightly arranged in hexagons. Both the diameter of each circle and a gap between the circles are 3 μm. The light source intensity of a mask aligner is approximately 18 mW/cm², and exposure duration is approximately 7 seconds.

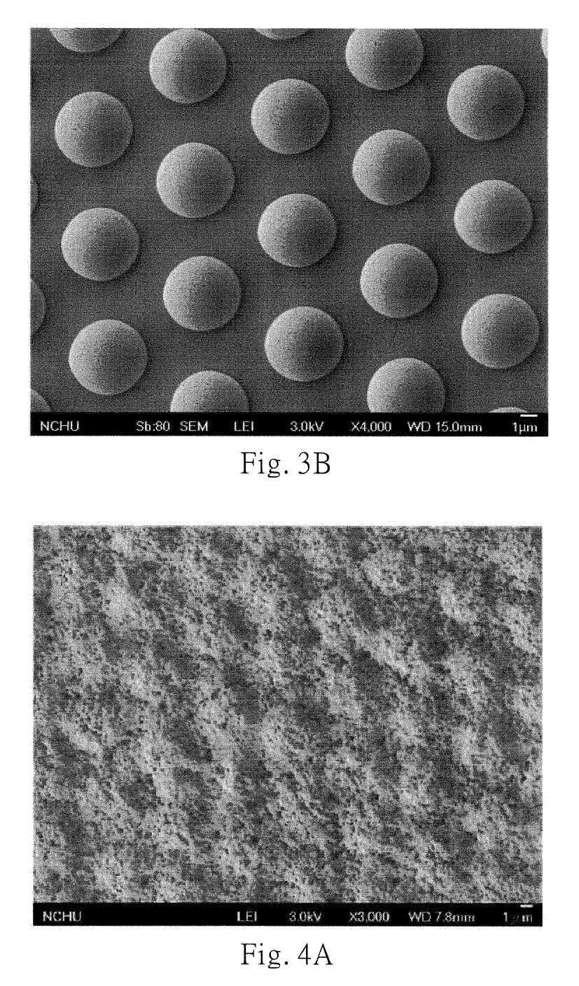

The die for which exposure is completed is immersed in a developing solution (2.38% TMAH) for development. The duration is approximately 90 seconds. A hexagonal cylindrical array chip is obtained, as shown in FIG. 3A. A development status needs to be confirmed by using an optical microscope, so as to prevent a photoresist residue from affecting the integrity of a photoresist structure.

Step of heat fusion processing and thin gold film sputtering

Referring to FIG. 3B, heat fusion processing is performed on the hexagonal cylindrical array chip at a temperature of approximately 160° C. for approximately 5 minutes, to turn a cylindrical array into a hemispherical array, so as to form a hemispherical array chip, and the diameter of the hemisphere is approximately 4 μm.

A thin gold film is then sputtered on a surface, having a hemispherical array, of the hemispherical array chip by using a direct-current sputter, so that a thin gold film covers each hemispherical surface to form an electrode. The sputtering pressure is 0.08 mbar, the current is 30 mA, and the duration is 135 seconds. Subsequently, annealing is performed at 120° C., and cooling is performed to the room temperature.

Surface Modification Step

The hemispherical array chip is placed in an alcohol solution that contains 5 mM of 1,6-hexanedithiol (1,6-HDT) for approximately 18 hours. After an end of 1,6-HDT is connected to a surface of each electrode, the hemispherical array chip is rinsed with absolute alcohol and dried. 40 μl of a nanogold particle solution having a predetermined concentration is then dropped on the surfaces of the electrodes to enable the other end of 1,6-HDT to be bonded to a nanogold particle, so that a plurality of nanogold particles are stably and uniformly attached on the surface of each electrode, to form a plurality of modified electrodes. The modified hemispherical array chip is cut into a square chip whose size is 1 square centimeter, to obtain a microarray chip.

### Example 3: Electrode Modification Effect Test

The purified nanogold particle solution is diluted with double distilled water, and is prepared into nanogold particle solutions whose concentrations are 0.1 wt %, 1 wt %, 10 wt %, 25 wt %, and 50 wt % relative to the stock solution and an undiluted nanogold particle solution (whose concentration is 100 wt %).

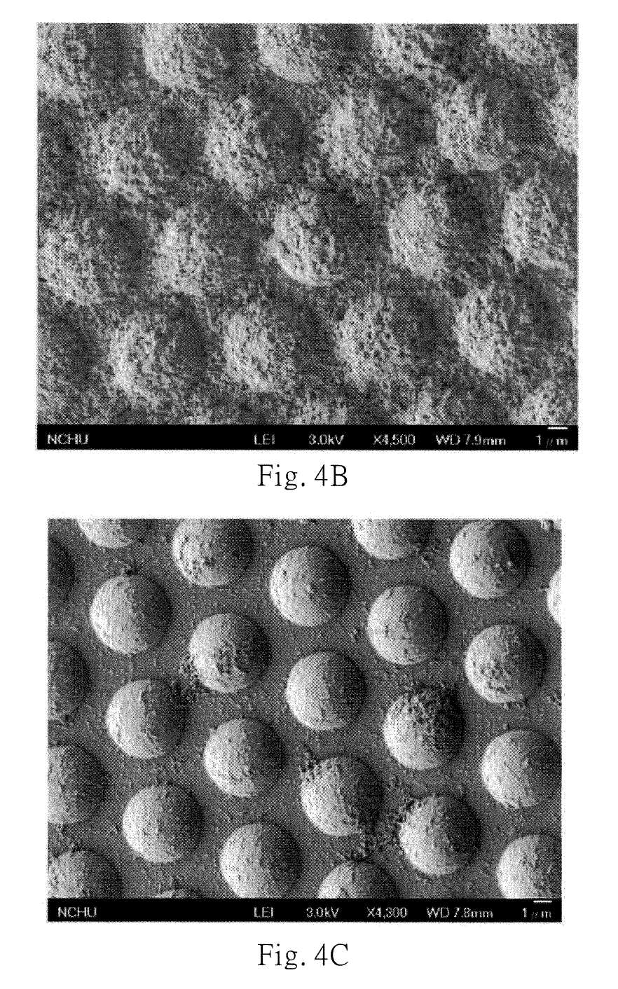

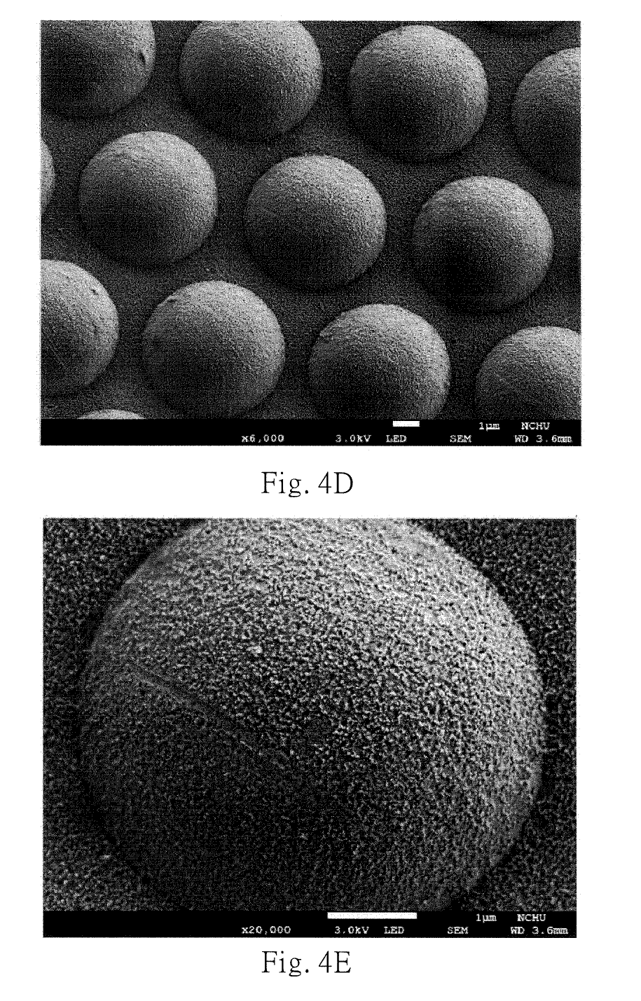

First, a microarray chip is prepared referring to the steps in Example 2. In the surface modification step, the nanogold particle solutions whose concentrations are 100 wt %, 50 wt %, 25 wt %, and 10 wt % are separately used. Structures of microarray chips modified by using the nanogold particle solutions having different concentrations are observed by using a field emission scanning electron microscope, and results are shown in FIG. 4A to FIG. 4E.

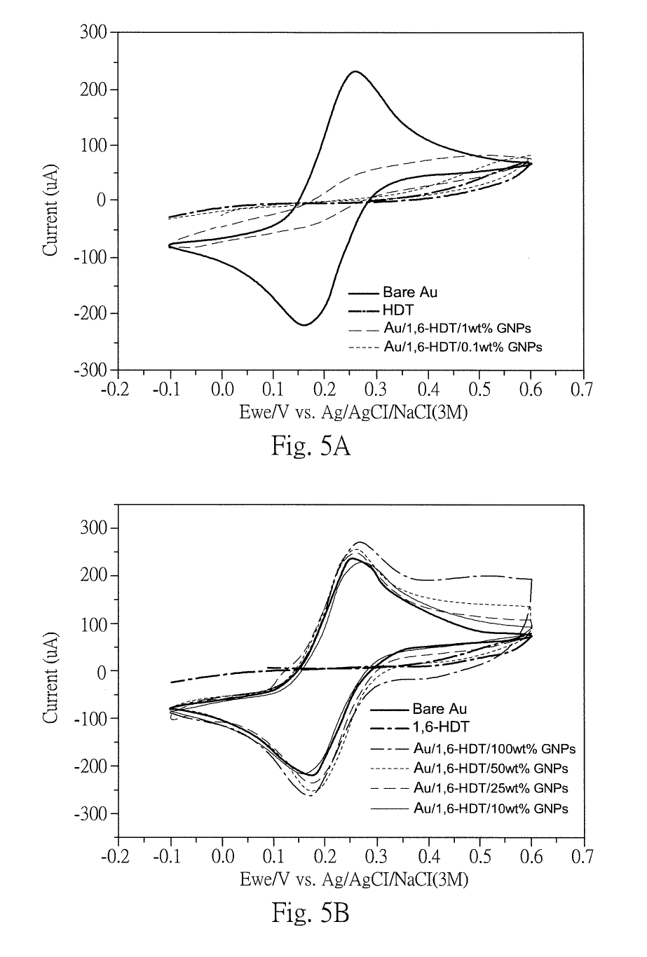

Moreover, referring to the content in Example 2, the nanogold particle solutions whose concentrations are 0.1 wt %, 1 wt %, 10 wt %, 25 wt %, 50 wt %, and 100 wt % are separately used to perform an electrode modification step to fabricate microarray chips that are modified by using different concentrations of nanogold particles, and electrical property differences of the microarray chips are detected by using CV. Results are shown in FIG. 5.

As can be learned from FIG. 4, when the concentration of nanogold particles is 100% or 50%, an excessively large quantity of nanogold particles cover the hemispherical array, and a hemispherical structure disappears as a result. When the concentration of nanogold particles is 25% or 10%, the nanogold particles can cover the hemispherical array and keep the structural integrity of the hemispherical array. Further, when the concentration of nanogold particles is 10%, the coverage has higher uniformity.

Moreover, when nanogold particles are attached on a microarray chip, a curve of an oxidation-reduction characteristic of the microarray chip is greater than that of a microarray chip on which no nanogold particle is attached. Therefore, results in FIG. 5 show that nanogold particles can be effectively fixed. In addition, the oxidation-reduction characteristic does not change as the concentration of nanogold particles increases.

As can be learned from the foregoing FIG. 4 and FIG. 5, in the method for modifying a non-planar electrode disclosed in the present invention, when a nanogold particle solution whose concentration is between 10 wt % and 75 wt % is used to perform electrode modification, a more desirable modification effect can be achieved.

### Example 4: 1,6-HDT Concentration Test

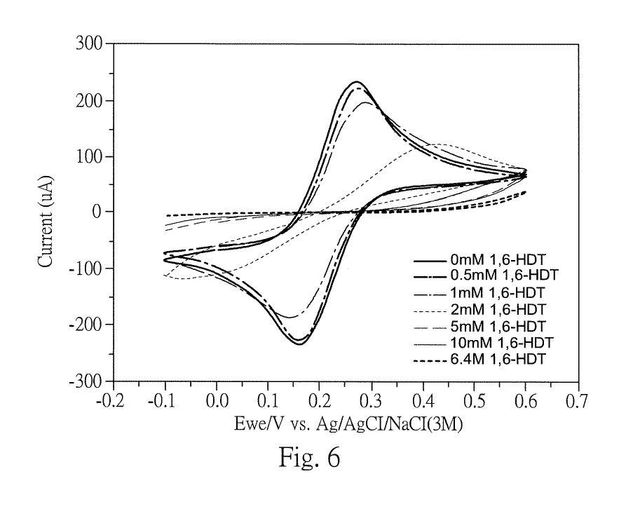

1,6-HDT solutions whose concentrations are 0.5 mM, 1 mM, 2 mM, 5 mM, 10 mM and 6.4 M are prepared, and a microarray chip is prepared according to the steps shown in Example 2. The 1,6-HDT solutions having the foregoing concentrations are used to perform a surface modification procedure. Oxidation and reduction reactions on the microarray chips processed by using the 1,6-HDT solutions having different concentrations are observed by using CV and it is determined whether a surface of an electrode is successfully modified. Results are shown in FIG. 6.

As can be learned from the results in FIG. 6, when the concentration of the 1,6-HDT solution decreases below 2 mM, oxidation and reduction reactions on the microarray chips are improved, showing that when the concentration of the 1,6-HDT solution is less than 2 mM, a gold electrode surface cannot be effectively covered. Therefore, in the method for modifying a non-planar electrode disclosed in the present invention, it is required to use a predetermined concentration of dithiol short straight-chain molecules as connectors for electrode modification. For example, the concentration of 1,6-HDT should not be less than 2 mM. For example, a 1,6-HDT solution whose concentration is 5 mM is used to perform an electrode modification step.

### Example 5: Measurement of a Surface Area of an Electrode

The nanogold particle solution concentration is prepared to be 10 wt %, the 1,6-HDT solution is prepared to be 5 mM, and a microarray chip is fabricated according to the steps disclosed in Example 2. In addition, a thin gold film is applied on a surface of a planar silicon chip whose size is 1 square centimeter to obtain a conventional planar gold electrode.

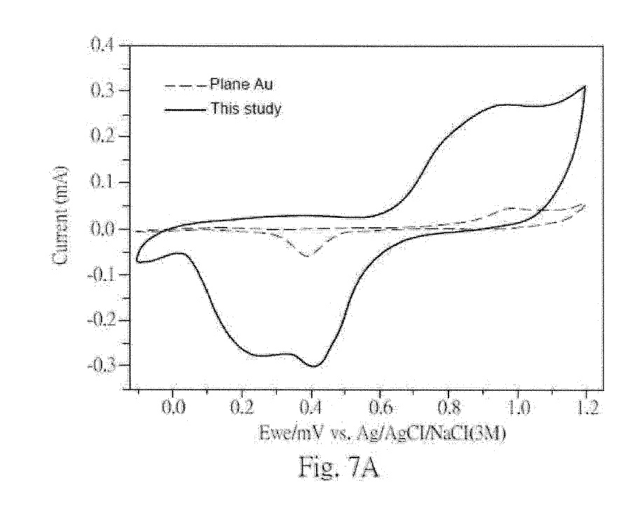

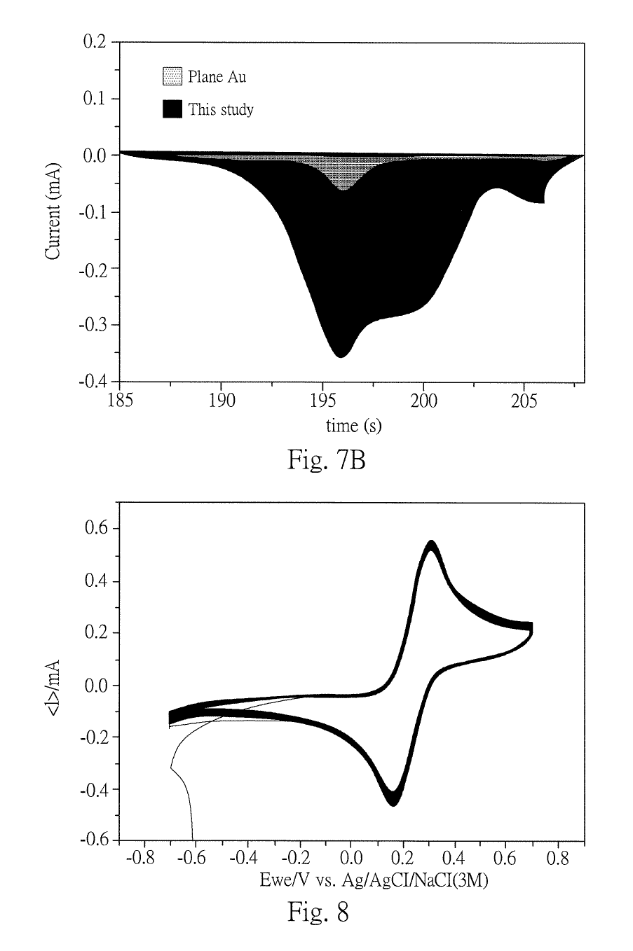

The microarray chip and the conventional planar gold electrode are separately placed in a 0.1 M phosphate solution, and a voltage between −0.1 V and 1.2 V is applied. Cyclic voltammograms of the conventional planar gold electrode and the microarray chip disclosed in the present invention are obtained through CV scanning. Results are shown in FIG. 7A, and are converted into a time-current curve, as shown in FIG. 7B.

Total electrical quantities (Q0) of the modified electrode on the microarray chip disclosed in the present invention and the conventional planar gold electrode can be separately estimated by performing integration on reduction currents in FIG. 7B. A total electrical quantity (Q0) of an electrode modified by using nanogold particles disclosed in the present invention is 2697 μC, and an electrical quantity (Qs) that can be absorbed by gold in each unit area is 390 μC/cm². Therefore, it can be estimated that an effective surface area (A=Q0/Qs) of the modified electrode disclosed in the present invention is 6.915 cm², and an effective surface area of the conventional planar gold electrode is only 0.283 cm². By comparison, an effective detection area of the modified electrode is 24.43 times as large as that of an unmodified electrode.

As can be learned from above, when an electrode is modified by using the method for modifying a non-planar electrode disclosed in the present invention, a detection area of the electrode can be effectively improved.

### Example 6: Stability Test

A microarray chip that is modified by using 5 mM 1,6-HDT and attached with 10% of nanogold particles is taken. A surface of the electrode is continuously and cyclically scanned by using CV to test the stability that nanogold particles are attached on the surface of the electrode. Results are shown in FIG. 8.

The results in FIG. 8 show that after the surface of the electrode is scanned by using CV for 80 cycles, and phenomena that nanogold particles fall off the electrode and an oxidation-reduction characteristic curve changes is not found, showing that the stability of the microarray chip disclosed in the present invention is very high. For a conventional chip deposited with gold particles by using APTMS, the phenomena that nanogold particles fall off the electrode and an oxidation-reduction characteristic curve changes occur when the surface of the electrode is scanned for 30 cycles. Therefore, it can be learned by comparing the microarray chip disclosed in the present invention with a conventional chip deposited with gold particles by using APTMS that the stability of the microarray chip disclosed in the present invention is increased to be 2.67 times as large.

### Example 7: Electrochemical Detection of Glucose

First, a microarray chip that is modified by using 5 mM 1,6-HDT and attached with 10% of nanogold particles is prepared.

(I) Electron Dispersion Rate Detection

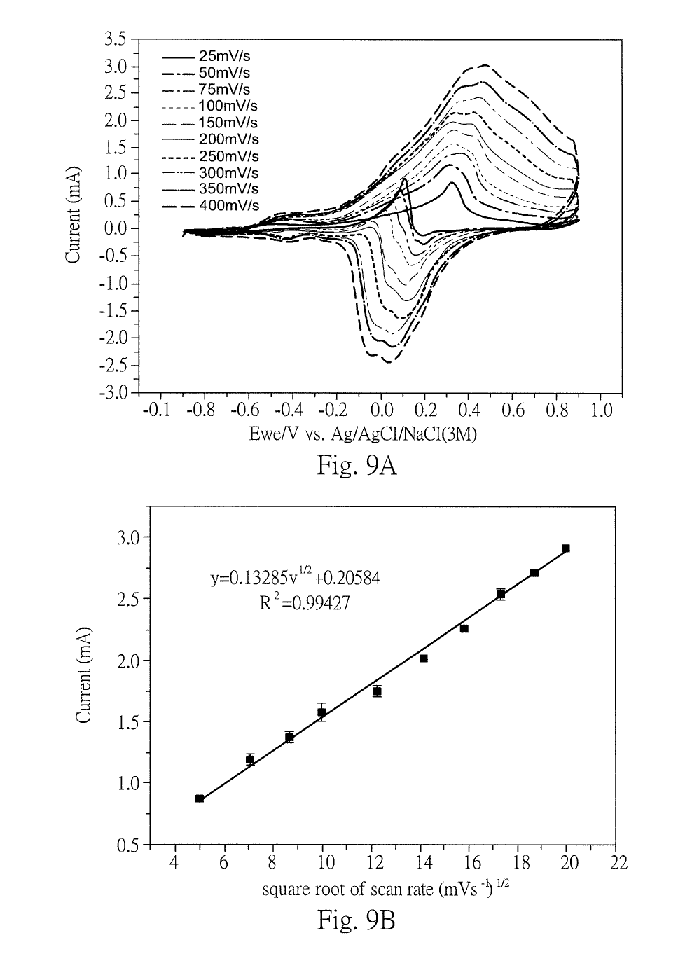

An electrolyte of mixing 6.94 mM glucose and 0.1 M sodium hydroxide is used, and the modified electrode of the microarray chip is scanned at various scan rates (25, 50, 75, 100, 150, 200, 250, 300, 350, and 400 mV/s). The obtained cyclic voltammograms are shown in FIG. 9A. A set electric potential scan range is −1.0 V to 1.0 V. FIG. 9A shows that a peak oxidation current increases as the scan rate increases, and a peak reduction current decrements as the scan rate increases.

Referring to FIG. 9B, FIG. 9B is a curve illustrating a relationship between a peak current and a scan rate drawn according to Randles-Sevcik equation. As can be learned from FIG. 9B, when an electron quantity n, a reaction area A, a concentration Co, a dispersion coefficient DR are constants, a peak oxidation current and a square root v^{1/2} of a rate have a linear relationship, showing that an electrode modified by using the method disclosed in the present invention exhibits electrochemical behavior of dispersion control and can be used to perform quantitative analysis.

(II) Glucose Concentration Detection

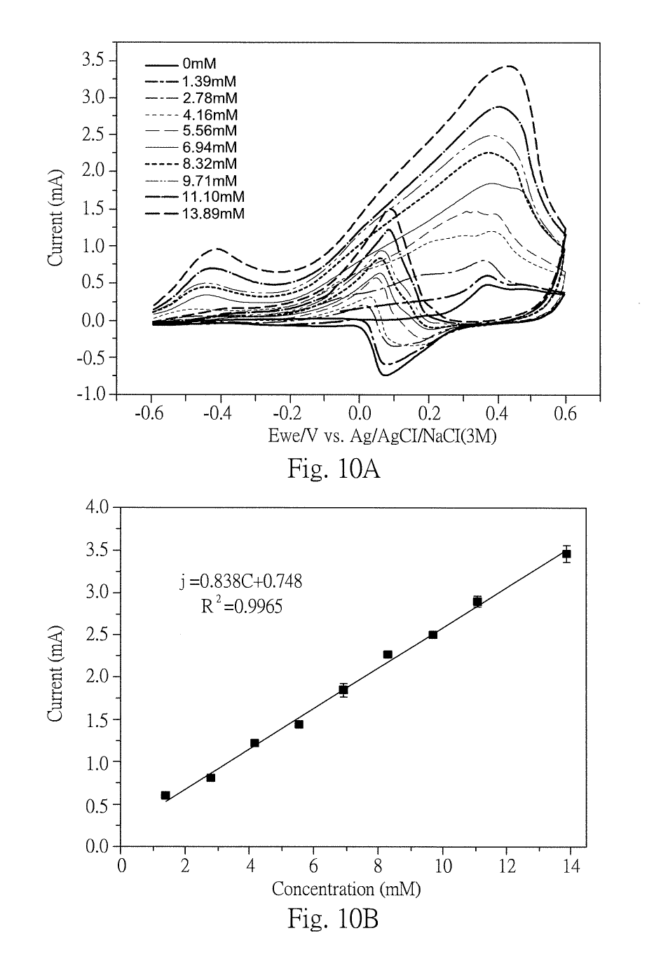

A voltage between −0.6 and 0.6 V is applied by using CV. A scan rate of 100 mV/s is used. Detection is performed in 0.1 M s odium hydroxide solutions that contain different concentrations of glucose being 0, 1.39, 2.78, 4.16, 5.56, 6.94, 8.32, 9.71, 11.10, and 13.89 mM. Results are shown in FIG. 10.

As learned from FIG. 10A, a peak current is directly proportional to a glucose concentration, and there are three obvious peaks in FIG. 10A. The first peak electric potential is −0.45 V, representing the formation and adsorption of gluconic acid. The remaining two peak electric potentials are 0.1 V and 0.4V, representing that glucose is directly oxidized in a cathode direction and an anode direction.

FIG. 10B is a diagram illustrating a relationship between a peak oxidation current (the electric potential is 0.4 V) and a corresponding glucose concentration, and for glucose solutions having different concentrations, three times of repeated tests are performed for each concentration. It is calculated that the microarray chip disclosed in the present invention has a sensitivity of 838.2 μA·mM⁻¹·cm⁻², a linear range of 1.39 mM to 13.89 mM, a correlation coefficient up to 0.9965, and a detection limit of 55.47 μM. Therefore, it shows that the microarray chip disclosed in the present invention has an excellent detection effect.

(III) Glucose Interfering Substance Test

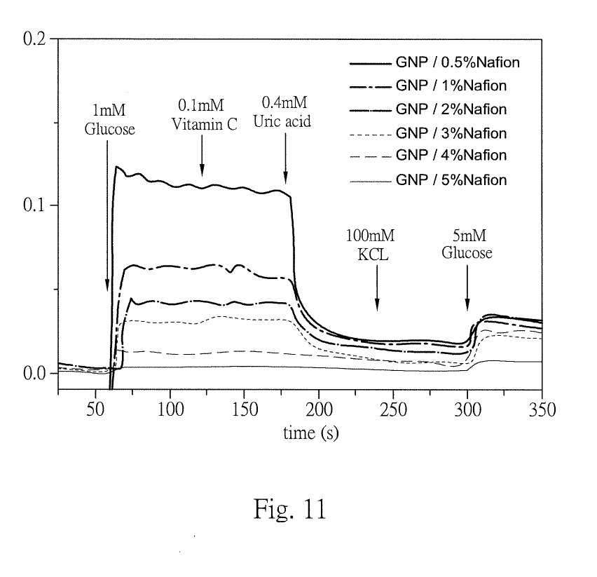

Ascorbic acid (AA), uric acid (UA), and potassium chloride (KCl) are used as interfering substances. A negatively charged membrane having selective permeability (Nafion® perfluorinated membrane, Nafion) is chosen as an anti-interfering substance of an electrode. An interfering substance reaction test is performed on the microarray chip disclosed in the present invention. A detection method is chronoamperometry. A detection electric potential is 0.2 V. In a detection step, 1 mM of glucose is added first. After a current becomes stable, 0.1 mM of AA, 0.4 mM of UA, and 100 mM of KCl are sequentially added, and 5 mM of glucose is then added. Detection results are shown in FIG. 11.

As can be learned from FIG. 11, when the concentration of Nafion applied on a surface of a modified electrode is higher, the anti-interference capability of the modified electrode is increased correspondingly. The concentration of Nafion needs to be greater than 4% to effectively block the three interfering substances. Moreover, as the concentration of glucose increases, the current rises obviously again. Therefore, it also shows that Nafion can in fact eliminate the impact of foreign interfering substances without affecting the reaction of glucose. As can be learned, Nafion whose concentration is above 4% can be further applied on the microarray chip or the modified electrode disclosed in the present invention to improve the effect of counteracting interfering substances.

### REFERENCE NUMERALS

| | |
|---|---|
| (10) Substrate | (20) Photoresist layer |
| (30) Cylindrical array | (40) Hemispherical array |
| (50) Slide | (60) Conductor |
| (70) Sealing film | |

What is claimed is:

1. A method for modifying a non-planar electrode, wherein a short-chain molecule is used to attach nanoparticles on a non-planar electrode, and the short-chain molecule is an alcohol compound having a thiol group at both ends.

2. The method for modifying a non-planar electrode according to claim 1, comprising the following steps:
Step a: placing at least one electrode in a dithiol solution whose concentration is greater than 2 mM, to enable an end of a dithiol to be attached on a surface of the electrode; and
Step b: placing a plurality of nanogold particles on the electrode in Step a, to enable the other end of the dithiol to be bonded to a nanogold particle.

3. The method for modifying a non-planar electrode according to claim 2, wherein the diameter of the nanogold particle is 1 nanometer to 50 nanometers.

4. The method for modifying a non-planar electrode according to claim 2, wherein the nanogold particle is prepared into a solution whose concentration is between 10 wt % and 75 wt %.

5. The method for modifying a non-planar electrode according to claim 1, wherein the electrode is a micron-sized protrusion.

6. The method for modifying a non-planar electrode according to claim 1, wherein the electrode is hemispherical, and the diameter of the electrode is 1 micron to 20 microns.

7. The method for modifying a non-planar electrode according to claim 1, wherein the electrode is disposed on a substrate.
